(19) United States
(12) Patent Application Publication
(10) Pub. No.: US 2025/0300257 A1
(43) Pub. Date: Sep. 25, 2025

(54) FROM EV BATTERY RECYCLING TO COMMERCIAL-SCALE PRODUCTION OF LITHIUM-ION BATTERY PRECURSOR (PCAM) USING GREEN SOLUTION

(71) Applicants: Rachid Essehli, Knoxville, TN (US); Souhir Sabri, Knoxville, TN (US)

(72) Inventors: Rachid Essehli, Knoxville, TN (US); Souhir Sabri, Knoxville, TN (US)

(21) Appl. No.: 18/609,783

(22) Filed: Mar. 19, 2024

(51) Int. Cl. H01M 10/54; C22B 3/16; H01M 4/505; H01M 4/525

(52) U.S. Cl. CPC H01M 10/54; C22B 3/1608; H01M 4/505; H01M 4/525

(57) ABSTRACT

The present invention pertains to a sustainable and efficient method for recycling lithium-ion batteries (LIBs) and producing lithium-ion battery precursor (pCAM) cathode precursors. In the recycling aspect, the invention introduces a green solvent mixture comprising Ethylene glycol phosphite (2-hydroxyethyl dihydrogen phosphite) and water, and not limited to the mixture Ethylene glycol, H₃PO₄ and water (H₂O) or a mixture of Ethylene glycol, H₂SO₄ and water H2O, for leaching valuable metal ions from spent cathodes and ore minerals. This method exhibits outstanding extraction efficiency, with 99.9% recovery rates for nickel, cobalt, manganese, and 99.5% for lithium. In the pCAM synthesis aspect, a novel method that produces pCAM in the spherical hydroxide form using ammonium metal (ii) sulfate hexahydrate (NH4)₂M(SO4)₂·6H2O, where M represents nickel(II), manganese(II), and cobalt(II), or combinations thereof.

### BACKGROUND OF THE INVENTION

The present invention pertains to a novel process designed for the environmentally friendly recovery of metals from lithium-ion battery waste streams. The method is characterized by its efficiency, sustainability, and reduced environmental impact, making it a significant advancement in the field of battery waste recycling. Mixed metal hydroxide precursors are vital components in the synthesis of cathode active materials for various energy storage applications, particularly in rechargeable batteries. Conventionally, their production involves the use of ammonia-based processes, which pose environmental and operational challenges.

The disclosed invention addresses these concerns by introducing an efficient and eco-friendly ammonia-free method for generating precursor cathode active materials, pCAM. The increasing use of lithium-ion batteries (LIBs) in various applications has led to a growing concern about the efficient recycling of spent batteries and the recovery of valuable metals, including lithium, cobalt, nickel, and other components. Traditional recycling methods involving inorganic acid leaching have limitations such as environmental impact, slow processing, low product purity, and the use of environmentally harmful chemicals. We can potentially reduce costs and energy consumption associated with traditional metal extraction methods.

### SUMMARY OF THE INVENTION

The invention revolutionizes battery recycling and pCAM production by offering a sustainable, efficient, and environmentally friendly solution to address critical challenges in the industry.

The present invention introduces a green method for recovering metals from a lithium-ion battery waste stream is provided that overcomes the drawbacks of conventional recycling. This method is sustainable, low in carbon emissions, efficient, cost-effective, and environmentally friendly. It achieves closed-loop recycling with high leaching efficiency and straightforward separation processes. Valuable metals including Nickle (Ni), Cobalt (Co), Manganese (Mn), and Lithium (Li) can be extracted with remarkable efficiency rates of up to 99.9%.

Other advantages of this disclosed subject is separation of Nickel (Ni) from Cobalt (Co), Manganese (Mn) mixture offering advantages over conventional organic solvent-extraction process. In a further aspect, a separation efficiency for each of cobalt (Co), Nickle (Ni), and manganese (Mn) is greater than or equal to about 99.5˜99.7% respectively.

In one aspect, the increasing of the pH of the filtrate liquid stream comprises first adding for example (NH₄)₂SO₄ as coprecipitation agent to the formation of (NH₄)₂M(SO₄)₂·nH₂O, where M represents nickel(II) cation, cobalt(II) cation, manganese(II) cation, or combinations thereof and n is 1<n<10 with high impurity 99.5˜99.7%.

According to one aspect of the present disclosure, an ammonia-free process to synthesis of pCAM cathode precursors prior to the co-precipitation process using (NH₄)₂M(SO₄)₂·nH₂O salt, where M represents Nickle(II) cation, cobalt(II) cation, manganese(II) cation, or combinations thereof. In another aspect, the one or more recovered pCAM products is an precursor having a stoichiometry of NixMnyCo1-x-y(OH)₂, where x is <1 and y is <1 with highly pure battery grade.

In one aspect, the process further comprises determining a first ratio of Ni:Mn:Co in the purified crystal (NH₄)₂M(SO₄)₂·nH₂O as a salt to the co-precipitation process. The first ratio is then compared to a target stoichiometric ratio of Ni:Mn:Co for the one or more recovered products. The process may include adding one or more individual salt nickel sulfate (NH₄)₂Ni(SO₄)₂·nH₂O, manganese sulfate (NH₄)₂Mn(SO₄)₂·nH₂O, and cobalt sulfate (NH₄)₂Co(SO₄)₂·nH₂O to the Co-precipitation solution to adjust an amount of nickel(II), manganese(II) and cobalt(II). In this manner, the one or more recovered products has a second ratio corresponding to the target stoichiometric ratio.

According to one aspect of the present disclosure, a process ammonia-free for producing highly pure battery grade metal carbonate having a stoichiometry of NixMnyCo1-x-yCO₃, where x is <1 and y is <1 with highly pure battery grade is in a range from 99.5% to 99.7%

In one aspect the intermediate liquid stream comprises lithium sulfate Li₂SO₄, lithium ammonium sulfate (NH₄LiSO₄).

Another benefit of the disclosed process offers an additional advantage through the recrystallization of ammonium sulfate (NH4)₂SO₄) employed in coprecipitation contributing to a cost-effective approach. The inter liquid stream is subjected to a thermal process so that a temperature is greater than or equal to about 70° C.

Another benefit of the disclosed method is its avoidance of sodium sulfate (Na2SO4)

byproduct generation. This not only eliminates considerable waste but also mitigates the embedded emissions associated with the consumption of chemicals.

In one aspect this process is designed to be sustainable, using less energy and generating less waste than current recycling methods, making it a more cost-effective and viable choice.

The key innovation lies in the use of a green solvent mixture comprising (1) Ethylene glycol phosphite, specifically (2-hydroxyethyl dihydrogen phosphite) and water, (2) not limited to the mixture of Ethylene glycol (EG)I, phosphite acid (H₃PO₃) and water (H₂O). This mixture is employed for efficient leaching of spent cathodes, nickel-metal hydride battery and ore minerals. The process involves cutting and shredding the spent cathodes (e.g., LiFePO₄, NMC111, NMC523, NMC622, NMC811, NCA, LiNiO₂, LiNi_{0.5}Mn_{1.5}O₄ or LCoO₂) and immersing them in the green solvent mixture. Leaching in the described process takes place at elevated temperatures 80 to 120° C. within approximately one hour, allowing for the dissolution and extraction of precious metal ions while leaving undissolved unreacted carbon black films and graphite in the solution. The high boiling point of Ethylene glycol (EG) ensures rapid leaching within approximately one hour under high-temperature conditions. After the leaching process, unreacted carbon black films and graphite can be efficiently filtered and separated from the metal leachate.

Subsequently, the collected metal leachate is kept at room temperature, where coprecipitation is achieved by adding an extra chemical, such as A₂SO₄ wherein A is an alkali metal for example A=NH₄, Na, K, Cs, Rb and/or combinations thereof. This step leads to the formation of a transition metal(ii) sulfate hydrate with compounds of the chemical formula A₂M(SO₄)₂·nH₂O, and M is one or more additional metals but not limited to Ni, Co, Mn. This innovative process enables the extraction of these valuable metals from the black mass and scraps leftover from batteries with an exceptional efficiency rate of 99.9% for nickel, cobalt, and manganese. The complex transition metal(ii) sulfate hydrate can be used to prepare the pCAM cathode precursors.

### Ammonia-Free Process for Synthesis of pCAM Cathode Precursors

Additionally, the invention addresses the challenges associated with traditional methods of synthesizing pCAM cathode precursors that use ammonia as a chelating agent. The conventional approach involves co-precipitation in a Continuous Stirred Tank Reactor (CSTR) to generate precursors in either their carbonate or hydroxide forms. To influence the morphology and particle size during this co-precipitation process, ammonia (NH₃·H₂O) has been utilized as a chelating agent. However, this approach not only leads to increased production costs but also necessitates substantial amounts of water for washing and filtration, resulting in waste byproducts. Furthermore, the handling and separation of ammonia in the process pose environmental hazards and result in the generation of toxic waste due to its toxic, corrosive, irritating, and volatile properties, potentially leading to the corrosion of production facilities and health risks, as well as air pollution. The absence of ammonia in the synthesis process could address these concerns and potentially offer advantages in terms of operational simplicity and environmental friendliness.

In some exemplary embodiments to overcome these challenges, the invention proposes the synthesis of pCAM in the spherical hydroxide form ammonium metal(ii) sulfate hexahydrate (NH₄)₂M(SO₄)₂·6H₂O, where M represents nickel(II), cobalt(II), manganese(II), or combinations thereof as both ammonia and transition metal sources. This synthesis occurs via a co-precipitation method that eliminates the need for ammonia as a chelating agent. The development of an efficient and ammonia-free synthesis method for pCam precursors could have implications for improving the overall sustainability and practicality of the production process, making it more suitable for industrial applications. The resulting pCAM hydroxide M(OH)₂ precursor powder where M=Ni(II), Co(II), Fe(II) and Mn(II) or and/or combinations thereof is separated from the aqueous medium, washed, and after filtration, dried in a vacuum oven at 120° C. for several hours. Subsequently, stoichiometric amounts of LiOH, LiOH·2H₂O, Li₂CO₃ are mixed with the prepared cathode materials (e.g., NMC111, NMC523, NMC622, NMC811, NCA, NMA, NMCA, LiNiO₂, LiFeO₂, Li₂MnO₃, LCoO₂ or LiNi_{0.5}Mn_{1.5}O₄), followed by calcination under O₂ atmospheres.

### 1-Synthesis of (NH₄)₂M(SO₄)₂·6H₂O where M═Ni and Mn From Recycling From NMC811

In an additional embodiment of the invention, an AAMTECH Reactor that has the capabilities to perform the recycling process is disclosed. Proposed here is a modified hydrometallurgy method, which is efficient, facile, low-cost and environmentally friendly by replacing the traditional inorganic acid with an aqueous solvent. The aqueous solvent comprises the green mixture of Ethylene glycol (EG), phosphite acid (H₃PO₃) and water for efficient spent cathodes leaching and following coprecipitation with adding safer and low-cost chemical for the precipitation. The phosphite acid (H₃PO₃) is dissolved in 500 ml mixed ethylene glycol and water (1:4 V/V) at 2 mol/I. After 1.00 g spent cathode NMC811 is added in the prepared green mixed in Ethylene glycol (EG), phosphite acid (H₃PO₃) and water and keep stirring under high temperature (80° C.) for leaching. Benefit from the high boiling point of Ethylene glycol solvent, the leaching process could be achieved within 1 hour under high temperature. Once the leaching process is completed, due to the selective reaction between phosphite acid (H₃PO₃) and cathode materials, the unreacted carbon black films are trapped and removed by the filtration unit, with metal solution streaming down to the next tank as illustrated in (FIGS. 1 and 2). Subsequently, the filtrate liquid stream consists of nickel (Ni), manganese (Mn), cobalt (Co) and Lithium (Li) stirring under room temperature for coprecipitation. First the nickel (Ni), was separated from metal leachate at room temperature, while gradually elevating the pH of the liquid stream by introducing 75 g (NH₄)₂SO₄ as a coprecipitate agent for the formation of pure ammonium Nickle(ii)sulfate hexahydrate (NH₄)₂Ni(SO₄)₂·6H₂O. The precipitate was trapped and removed by the filtration unit, the remaining solution containing manganese (Mn), and cobalt (Co) and Lithium streaming down to the next tank as illustrated in (FIGS. 1 and 2). The solution will be maintained at 60 0 C and coprecipitates through the addition of 50 g of oxidizing agent (NH₄)₂S₂O₈. Mn2+ in the leachate is oxidized and precipitated as manganese dioxide MnO₂. The precipitation reaction that takes place is: Mn₂++S₂O₈2−+2H₂O→MnO₂+2SO₄2−+₄H+. Manganese dioxide, MnO₂, is a valuable precipitate that can have various applications, including as a component in battery cathodes, water treatment processes, and as a catalyst in certain chemical reactions. Then the manganese dioxide (MnO₂) is continually added to a mixture of 10 g of (NH₄)₂SO₄ and 100 ml of H₂SO₄ 2 mol/I solution to prepare ammonium manganese (ii) sulfate hexahydrate (NH₄)₂Mn(SO₄)2.6H₂O. The remaining solution consisting of cobalt (Co) and Lithium (Li), was subsequently maintained at room temperature, where coprecipitation occurs by adding 20 g of (NH₄)₂SO₄, to the remaining solution to create the ammonium cobalt(ii) sulfate hexahydrate (NH₄)₂Co(SO₄)2.6H₂O. The remaining solution consisting of Lithium (Li) solution, was then maintained at 60° C. to precipitate and crystallize the mixture of Li₂SO₄ and NH₄LiSO₄, trapped and removed by the filtration unit with the remaining solution streaming down to the next tank.

The remaining solution was subsequently maintained at 70° C. to crystallize the (NH₄)₂SO₄, trapped and removed by the filtration unit with the remaining solution streaming down to the next tank. This controlled temperature is conducive to the formation of well-defined crystals of ammonium sulfate, a key step in the coprecipitation method. The crystallized ammonium sulfate obtained at this temperature exhibits desirable characteristics that can be advantageous for subsequent coprecipitation processes. The remaining solution was maintained at 80° C. to crystallize (NH₄)₃Al(H₃PO₃)₆ trapped and removed by the filtration unit. The formed (NH₄)₃Al(H₃PO₃)₆ is a bio-product with versatile applications in water treatment. Another benefit of this project is its avoidance of sodium sulfate (Na₂SO₄) byproduct generation. This not only eliminates considerable waste but also mitigates the embedded emissions associated with the consumption of chemicals. The selective reaction effectively avoids impurities in the metal leachate and facilitates the following separation. In the meanwhile, the leaching efficiency reaches 98%

### BRIEF DESCRIPTION OF DRAWINGS

FIG. 1 illustrates the lab equipment used to take shredded spent LIBs 1 and subject them to a green solvent mixture 5 of glycol phosphite (specifically, 2-hydroxyethyl dihydrogen phosphite) and water not limited to the mixture of Ethylene glycol(EG), phosphite acid (H₃PO₃) and water (H₂O) or phosphite acid (H₃PO₃) and water (H₂O), efficiently leaching valuable ions from the spent LIBs 1. The leaching takes place at elevated temperatures (80-120 C) 6 ensuring the dissolution and extraction of precious metals while leaving undissolved solid graphite 2 in the solution as illustrated in FIG. 1. The collected metal leachate 11 consisting of nickel (Ni), manganese (Mn), cobalt (Co) and Lithium (Li) (shown in FIG. 3) streaming down to the next tank. First the nickel (Ni) is separated from metal leachate 11 at room temperature (RT) 9, where coprecipitation occurs by adding (NH₄)₂SO₄. 3. The coprecipitation results in the formation of ammonium metal (ii) sulfate hexahydrate (NH₄)₂M(SO₄)₂·6H₂O 8, where M represents nickel(II), manganese(II), and cobalt(II), or combinations thereof. The precipitate is trapped and removed by the filtration unit 7, the remaining solution 12 containing manganese (Mn), and cobalt (Co) and Lithium (Li) streaming down to the next tank. The solution 12 is maintained at 60° C. 13 and through the introduction of an oxidizing agent (NH₄)₂S₂O₈, 10, coprecipitation occurs. Mn²⁺ in the leachate 12 is oxidized and precipitated of manganese dioxide MnO₂ 14. Manganese dioxide (MnO₂) 14, is a valuable precipitate that can have various applications, including as a component in battery cathodes, water treatment processes, and as a catalyst in certain chemical reactions. This precipitation step is crucial for the selective removal and recovery of manganese (Mn) from the leachate 12, preventing it's continued presence in the leachate 12. Then manganese dioxide 14 is continually added to mixture of (NH₄)₂SO₄ and H₂SO₄ 15 solution to prepare ammonium manganese (ii) sulfate hexahydrate (NH₄)₂Mn(SO₄)₂·6H₂O 16. The remaining leachate 17 consisting of cobalt (Co) and Lithium (Li) streaming down to the next tank, is subsequently maintained at room temperature (RT) 18, where coprecipitation occurs by adding (NH₄)₂S₂O₈, (NH)₂CO₃, NH₄OH to the remaining solution to create the ammonium Nickel(ii) sulfate hexahydrate (NH₄)₂Co(SO₄)₂·6H₂O, CoCO₃ and Co(OH)₂ 19. The remaining leachate 20 consisting of Lithium (Li) solution, is subsequently maintained at 60° C. 21 to precipitate and crystallize the mixture of Li₂SO₄ and NH₄LiSO₄, which is trapped and removed by the filtration unit 22 with the remaining solution streaming down to the next tank. The remaining solution is subsequently maintained at 70° C. to crystallize (NH₄)₂SO₄, trapped and removed by the filtration unit with the remaining solution streaming down to the next tank. This controlled temperature is conducive to the formation of well-defined crystals of ammonium sulfate, a key step in the coprecipitation method. The crystallized ammonium sulfate obtained at this temperature exhibits desirable characteristics that can be advantageous for subsequent coprecipitation processes. These crystals, once formed, can be utilized as a precursor material in various coprecipitation methods. The remaining solution is subsequently maintained at 80° C. to crystallize (NH₄)₃Al(H₃PO₃)₆ trapped and removed by the filtration unit. The (NH₄)₃Al(H₃PO₃)₆ is a bio-product with versatile applications in water treatment.

FIG. 2 illustrates three examples of FIG. 1 showing a 99.9% extraction rate efficiency for nickel(II), manganese(II), and cobalt(II), and a 99.5% extraction rate efficiency for lithium.

FIG. 3 illustrates the jars of first, the green solvent solution 5, then the jar of metal leachate 11, then the jar of nickel precipitate 3, then the jar of cobalt solution 18 and finally the jar of lithium solution 20. Underneath the jars the dried precipitate is shown with first small jars of the precipitate, and then pieces of paper with dried precipitate smeared on the paper

FIG. 3A illustrates the jars of first, the green solvent solution 5, then the jar of metal leachate 11, then the jar of nickel precipitate 3, then the jar of cobalt/manganese solution 40 and the jar of manganese solution 14, then the jar of cobalt/lithium solution 42 and finally the jar of lithium solution 20. The jars of cobalt/manganese solution 40 and cobalt/lithium solution 42 are intermediaries of the desired precipitants, manganese 14, cobalt 19 and lithium. Underneath the solution jars the dried precipitate is shown smeared on the paper nickel 3, manganese 14, cobalt, and finally lithium.

FIG. 4A-4C illustrate a synthesis flow chart detailing materials production via a continuous stirred tank reactor (CSTR) 30. A novel synthesis process for pCAM in the spherical hydroxide form using ammonium metal(ii) sulfate hexahydrate (NH4)₂M(SO4)₂·6H2O 32, where M represents nickel(II) 3, manganese(II) 14, and cobalt(II) 19, or combinations thereof as metal source and ammonium (NH4) chelating agent is disclosed. The flow rate for the ammonium metal(ii) sulfate hexahydrate (NH4)₂M(SO4)₂·6H2O 32, which is Solution A, is 0.5 l/hr. The flow rate for the sodium hydroxide NaAlO₂, Solution B, is 0.5 l/hr. Solution C 33 which is sodium hydroxide in DI water is used to maintain a pH of 11. There is continuous collection of cathode product 34. The CSTR 30 is operated 600 rpm at 55° C. The CSTR 30 is shown schematically on the left, then drawn connected up to the necessary controls on the right, then photographs of the CSTR 30 are shown below. The resulting pCAM hydroxide precursor powder is separated from the aqueous medium, washed, and, after filtration, dried in a vacuum oven at 120° C. for several hours. Stoichiometric amounts of Li₂OH 20 are mixed with the prepared cathode material, followed by calcination under O₂ atmospheres, yielding high-quality cathode material for use in lithium-ion batteries.

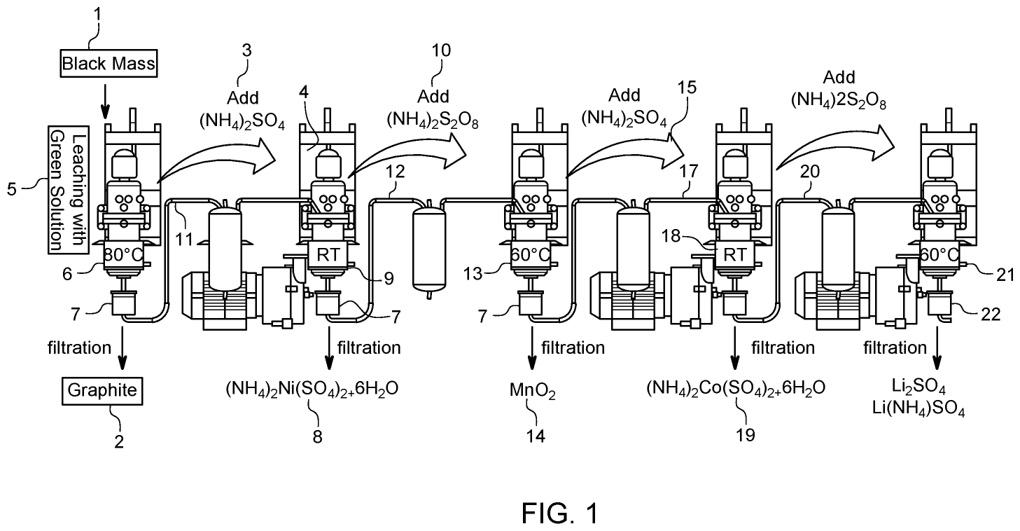

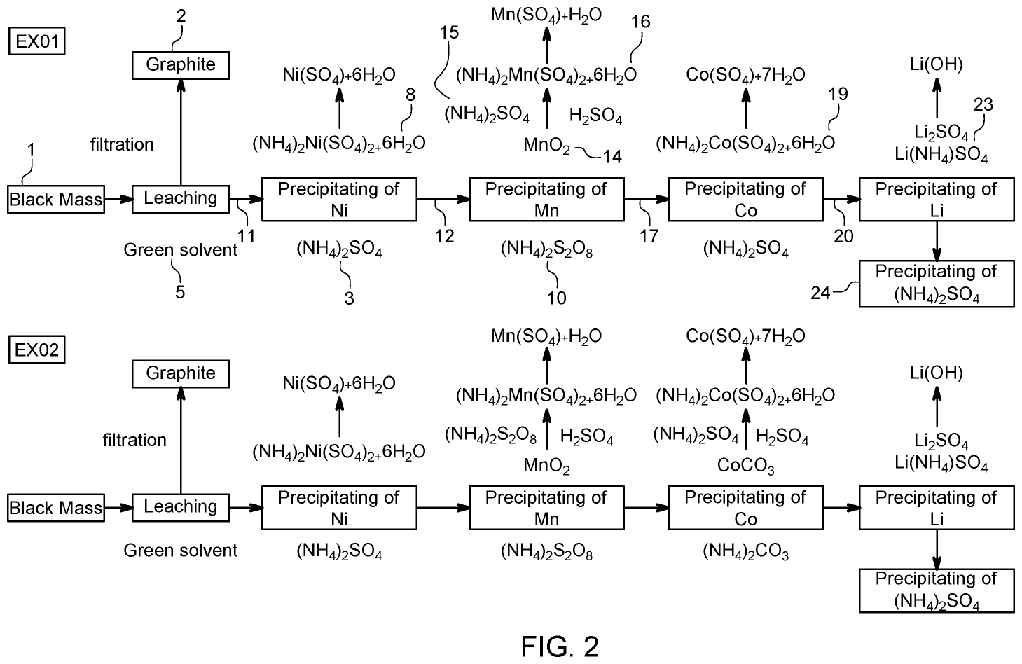

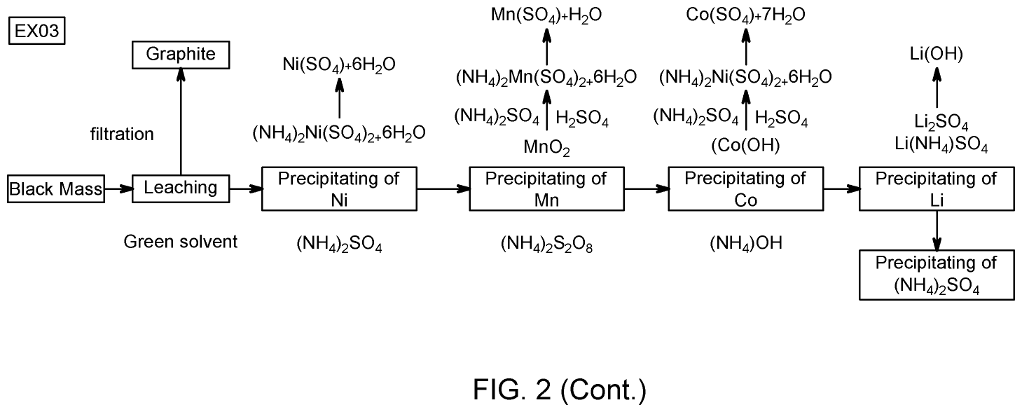

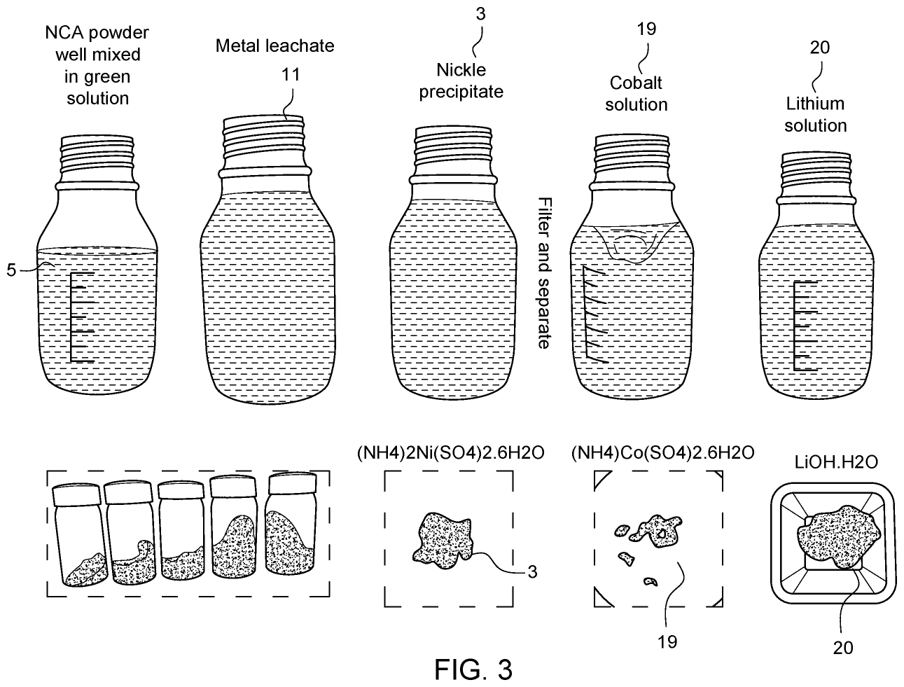

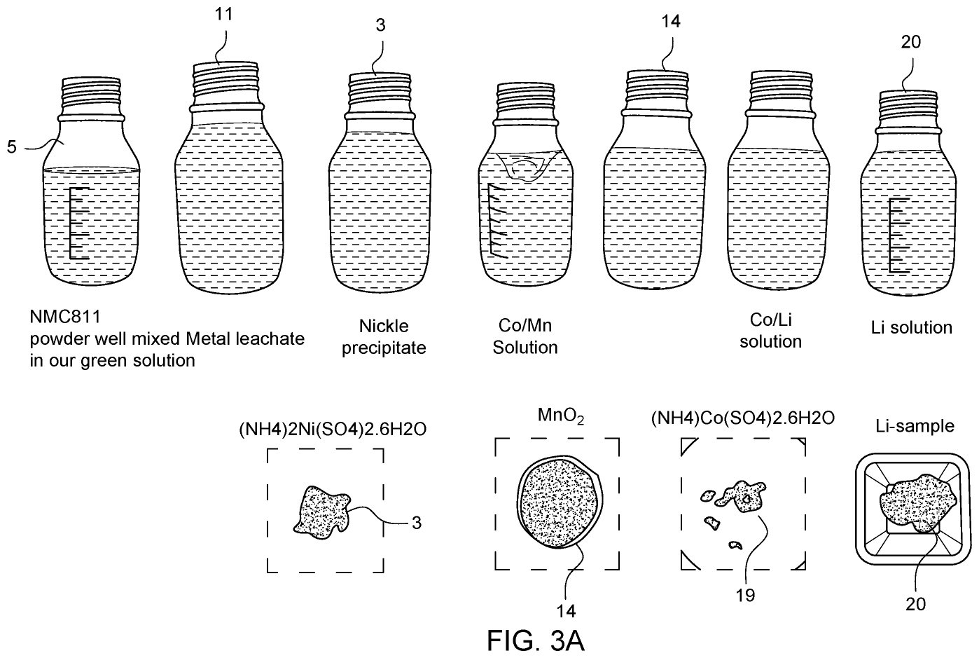

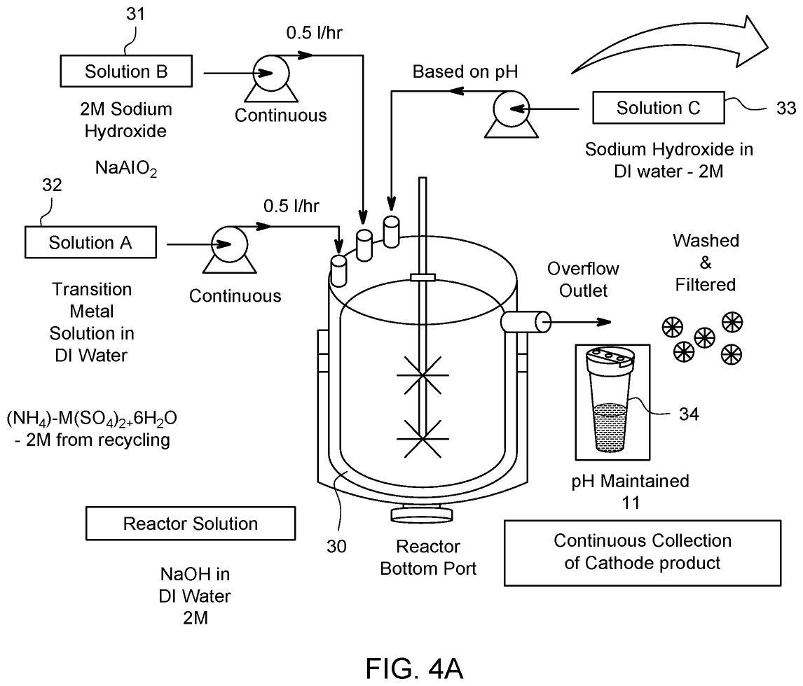

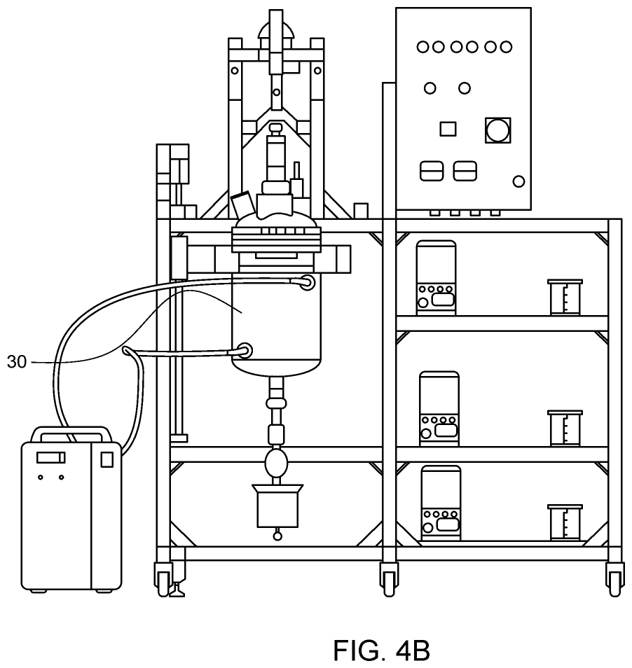

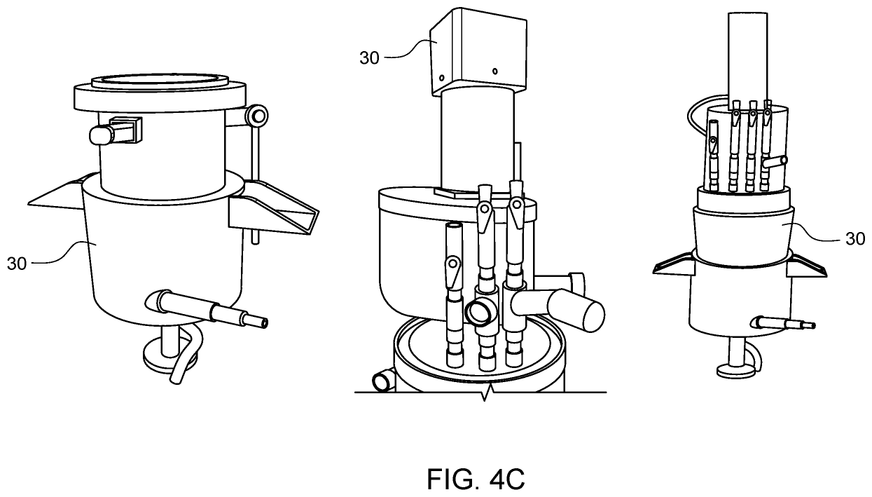

### DETAILED DESCRIPTION OF THE INVENTION

The invention encompasses a novel and sustainable method for recycling lithium-ion batteries (LIBs) and producing high-quality lithium-ion battery precursor (pCAM). This method overcomes the limitations of traditional recycling processes and addresses the challenges associated with synthesizing pCAM cathode precursors using ammonia.

The recycling process begins with the collection and shredding of spent LIBs 1, particularly those containing cathodes such as (e.g., NMC111, NMC523, NMC622, NMC811, NCA, NMA, NMCA, LiNiO₂, LiFeO₂, LizMnO₃, LCoO₂ or LiNi_{0.5}Mn_{1.5}O₄). The shredded material 1 is then subjected to a green solvent mixture 5, consisting of Ethylene glycol phosphite (specifically, 2-hydroxyethyl dihydrogen phosphite) and water and not limited to the mixture Ethylene glycol, H₃PO₃ and water (H₂O) or mixture of H₃PO₃ and water H₂O. This environmentally friendly mixture 5 facilitates efficient leaching of valuable metal ions from the spent cathodes 1, nickel-metal hydride battery (NiMH or Ni—MH) and ore minerals. The leaching process takes place at elevated temperatures (80-120° C.) 6, ensuring the dissolution and extraction of precious metals while leaving undissolved solid graphite 2 in the solution. Thanks to the high boiling point of Ethylene glycol and H₃PO₃ 5 as oxidizing agent, leaching is accomplished within approximately one hour under these conditions.

After completion of the leaching process, any remaining unreacted graphite 2 and or carbon black 2 is trapped and removed by the filtration unit 7 with the remaining metal solution 11 streaming down to the next tank.

Ni separation process: The collected metal leachate consisting of nickel (Ni), manganese (Mn), cobalt (Co) and Lithium (Li), 11 is subsequently maintained at room temperature (RT) 9, where coprecipitation occurs by adding (NH₄)₂SO₄ 3. The coprecipitation mechanism facilitates the simultaneous precipitation with high selectivity of ammonium Nickel (ii) sulfate hexahydrate (NH₄)₂Ni(SO₄)₂·6H₂O 8. The precipitate 8 is trapped and removed by the filtration unit 7, the remaining solution containing manganese (Mn), and cobalt (Co) and Lithium 12 streaming down to the next tank.

The remaining solution consisting of manganese (Mn), cobalt (Co) and Lithium (Li), 12 is subsequently maintained at 60° C. 13, where coprecipitation occurs by adding (NH₄)₂S₂O₈ 10 to the leaching solution 12. Mn²⁺ in the leachate is oxidized and precipitated of manganese dioxide MnO₂. 14. The precipitation reaction takes place is: Mn²⁺+S₂O₈²⁻+2H₂→MnO₂+2SO₄²⁻+4H⁸. The precipitate 14 is trapped and removed by the filtration unit 7 and the remaining solution 17 containing manganese (Mn), and cobalt (Co) and Lithium streaming down to the next tank. Then the manganese dioxide MnO₂ 14 is continually added to mixture of (NH₄)₂SO₄ and H₂SO₄ 15 solution to prepare ammonium manganese (ii) sulfate hexahydrate (NH₄)₂Mn(SO₄)₂·6H₂O 23.

The remaining solution 17 consisting of cobalt (Co) and Lithium (Li), is subsequently maintained at room temperature 18, where coprecipitation occurs by adding (NH₄)₂S₂O₈, (NH₄)₂CO₃, NH₄OH to the remaining solution to create the ammonium Nickel(ii) sulfate hexahydrate (NH₄)₂Co(SO₄)₂·6H₂O 19, CoCO₃ and Co(OH)₂.

The remaining solution consisting of Lithium (Li) solution 20, is subsequently maintained at 60° C. 21 to precipitate and crystallize the mixture of Li₂SO₄ and NH₄LiSO₄ 27, trapped and removed by the filtration unit 22 with the remaining solution 24 streaming down to the next tank. The remaining solution 24 is subsequently maintained at 80° C. to crystallize (NH₄)₂SO₄, which is trapped and removed by the filtration unit with the remaining solution streaming down to the next tank.

The remaining solution is subsequently maintained at 80° C. to crystallize (NH₄)₃Al(H₃PO₃)₆, trapped and removed by the filtration unit. The (NH₄)₃Al(H₃PO₃)₆ is a bio-product with versatile applications in water treatment.

### Ammonia-Free Process for Synthesis of pCAM Cathode Precursors

The invention also addresses the challenges associated with traditional methods of synthesizing pCAM cathode precursors, which rely on ammonia as a chelating agent. This conventional approach uses co-precipitation in a Continuous Stirred Tank Reactor (CSTR) 30 to form precursors in their carbonate or hydroxide forms, requiring significant quantities of ammonia, water, and generating hazardous waste.

The invention seeks to provide an alternative method that eliminates the reliance on ammonia, offering a more efficient, environmentally friendly, and practical approach to synthesizing pCam cathode precursors. By addressing these challenges, the innovation not only enhances the sustainability of the synthesis process but also improves the overall feasibility of scalability of producing pCam materials for various applications, particularly in the field of energy storage and catalysis. To overcome these challenges, the invention introduces a novel synthesis process for pCAM in the spherical hydroxide form using ammonium metal (ii) sulfate hexahydrate (NH₄)₂M(SO₄)₂·6H₂O, 32 where M represents nickel(II), manganese(II), and cobalt(II), or combinations thereof as metal source and ammonium (NH₄) chelating agent which is the key for this eco-friendly and cost-effective process. This innovative method eliminates the need for ammonia as a chelating agent, reducing pCAM production costs and environmental impact.

To produce active materials featuring NMC111, NMC523, NMC622, NMC811, the initial step involves preparing a solution of 2M ammonium metal(ii) sulfate hexahydrate 31 recovered from recycling of lithium-ion batteries denoted as (NH₄)₂M(SO₄)₂·6H₂O 32 where M represents nickel(II), manganese(II), and cobalt(II), or combinations thereof. A metal salt solution with a precisely calculated stoichiometric amount is meticulously formulated. Subsequently, 4 liters of distilled water are introduced into a CSTR reactor 30, boasting a capacity of 5 liters and powered by an 80 W rotation motor. Nitrogen gas is then introduced into the reactor at a rate of 0.5 liters per minute to eliminate dissolved oxygen. The stirring process commences at 800 rpm, maintaining a reactor 30 temperature of 50° C. throughout. This carefully orchestrated sequence of steps establishes the foundation for the synthesis of active materials with the specified NMC compositions. The initial metal salt solution 32 was consistently introduced into the reactor at a continuous rate of 0.3 liters per hour, complemented by a continuous infusion of 2M NaOH solution 31 also at a rate of 0.3 liters per hour. Additionally, to maintain the desired pH level at 11, a 4M sodium hydroxide (NaOH) solution 33 was continuously supplied for pH adjustment. The impeller speed of the reactor 30 was carefully regulated at 1000 rpm to facilitate the homogeneous coprecipitation reaction. Once the reaction had achieved a stable state, a duration of 12 hours in normal status was allotted to the reactants, ensuring the production of a coprecipitation composite with enhanced density.

The resulting pCAM hydroxide precursor powder is separated from the aqueous medium, washed, and, after filtration, dried in a vacuum oven at 120° C. for several hours. Subsequently, stoichiometric amounts of Li₂OH 20 are mixed with the prepared cathode material, followed by calcination under O₂ atmospheres, yielding high-quality cathode material for use in lithium-ion batteries.

Another embodiment according to this invention is a coprecipitation method to prepare the spherical NMCA(OH)2 precursor. The co-precipitation of Ni2+, Mn2+, or Co2+ with Al3+ proved challenging due to the significantly smaller Ksp of Al(OH)3 compared to Ni(OH)2, Mn(OH)2, and Co(OH)2. To address this issue, AlO²⁻ was employed as the aluminum source, capable of hydrolyzing into Al(OH)3 under specific pH conditions, ensuring the simultaneous co-precipitation of Ni2+, Mn2+, Co2+ and Al3+. The experimental setup involved a continuous stirred tank reactor (CSTR) 30 with a 5 L capacity operating under an N2 atmosphere. In the CSTR 30, 5 L of 1M NaOH solution was added and maintained at 55° C. Three types of solutions, designated as solution A 32, solution B 31, and solution C 33, were used. Solution A 32 comprised of a mixture of (NH4)2M(SO4)2.6H2O 32, where M represents nickel (II), manganese (II), cobalt (II) at a concentration of 2.0 M in deionized water. Solution B 31, totaling 5 L, resulted from the combination of NaALO2, NaOH (2.0 M) in deionized water. The elevated NaOH concentrations facilitated the conversion of Al3+ into AlO2−. Finally, solution C 33 was prepared as a 2.0 M NaOH solution. Solution A 32 and solution B 31 were added into the CSTR 30 with the 2 ml/min and 5 ml/min flow rate respectively. The pH of the mixed solution in the CSTR 30 was maintained at 11.5±0.2 by controlling the flow rate of solution C 33. The stirring speed and temperature of the solution in the CSTR 30 were controlled strictly. The resultant NMCA 34 precursor powder was filtered then washed with deionized water several times until the pH of the filtrate was close to 7.0. After sieving, powders with an average particle size of 10 um were used for further analyses. The Ni, Al and Fe contents of the as-prepared sample was 8:1:1 respectively, as confirmed by inductively coupled plasma-mass spectroscopy ICP-MS-analysis. The filtered powder was dried at 120° C. for overnight and then fired with appropriate amount of Li2CO3 at 700° C. and 750° C. for 20 hours under O2 to make NMCA 34.

1. A method for recycling lithium-ion batteries (LIBs), comprising:
a. Collecting spent LIBs, particularly those containing cathodes of NMC111, NMC622, NMC811, NCA, or LCoO₂ and LiNi_{0.5}Mn_{1.5}O₄ compositions;
b. Shredding the collected spent LIBs to facilitate further processing;
c. Subjecting the shredded material to a green solvent mixture, comprising Ethylene glycol phosphite (2-hydroxyethyl dihydrogen phosphite) and water and not limited to the mixture of Ethylene glycol (EG), H₃PO₄ and water (H₂O) or a mixture of Ethylene glycol (EG), H₂SO₄ and water (H₂O) or a mixture of Ethylene glycol (EG), HCl and water (H₂O), or a mixture of Ethylene glycol, HNO₃ and water (H₂O), at elevated temperatures (80-120° C.) to leach valuable metal ions from the spent cathodes and ore minerals.

2. The method of claim 1 and further comprising separating any remaining unreacted carbon black films from the metal leachate, and maintaining the collected metal leachate at room temperature and adding an extra chemical, such as (NH₄)₂SO₄, to facilitate coprecipitation.

3. The method of claim 2 and further comprising thereby forming ammonium metal(ii) sulfate hexahydrate (NH4)₂M(SO4)₂·6H2O, where M represents nickel(II), manganese(II), and cobalt(II), or combinations thereof.

4. The method of claim 3 wherein said method achieves exceptional efficiency with a 99.9% extraction rate for nickel(II), manganese(II), and cobalt(II), and a 99.5% efficiency for lithium.

5. A method for synthesizing lithium-ion battery precursor (pCAM) cathode precursors in the spherical hydroxide form, comprising using ammonium metal(ii) sulfate hexahydrate (NH4)₂M(SO4)₂·6H2O, where M represents nickel(II), manganese(II), and cobalt(II), or combinations thereof.

6. The method of claim 5 and further comprising producing pCAM hydroxide precursor powder by separating the pCAM hydroxide precursor powder from the aqueous medium, washing and filtering the pCAM hydroxide precursor powder; drying the filtered pCAM hydroxide precursor powder in a vacuum oven at 120° C. for several hours.

7. The method of claim 6 and further comprising mixing stoichiometric amounts of Li₂OH with the dried pCAM hydroxide precursor powder.

8. The method of claim 7 and further comprising performing calcination under O₂ atmospheres to yield high-quality pCAM suitable for use in lithium-ion batteries sequential order.
